(19) United States
(12) Patent Application Publication
(10) Pub. No.: US 2023/0347605 A1
(43) Pub. Date: Nov. 2, 2023

(54) FIBER MANUFACTURING METHOD

(71) Applicant: NITTO DENKO CORPORATION, Ibaraki-shi, Osaka (JP)

(72) Inventors: Hajime Michihira, Osaka (JP); Takashi Kumano, Osaka (JP); Tetsuya Takagi, Osaka (JP); Yuto Nagaya, Osaka (JP)

(73) Assignee: NITTO DENKO CORPORATION, Ibaraki-shi, Osaka (JP)

(21) Appl. No.: 18/025,741

(22) PCT Filed: Jun. 4, 2021
(86) PCT No.: PCT/JP2021/021456

§ 371 Date: Mar. 10, 2023

(30) Foreign Application Priority Data
Sep. 11, 2020 (JP) 2020-152801

(51) Int. Cl. B29D 11/00; D01D 5/088

(52) U.S. Cl. CPC B29D 11/00663; D01D 5/088

(57) ABSTRACT

The present invention provides a fiber manufacturing method suitable for reducing the variation in outer diameter. The fiber manufacturing method of an embodiment of the present invention includes: discharging a softened linear body 1 through a nozzle 10; and winding the linear body 1 so that the linear body 1 passes through a cooling portion 20 supplied with a cooling fluid 50, thereby obtaining a fiber 5. The cooling portion 20 has a filter 40 configured to rectify the cooling fluid 50. The cooling fluid 50 in the cooling portion 20 has a temperature that is substantially constant in a moving direction of the linear body 1. According to the fiber manufacturing method of the embodiment, an index M determined by the following equation (I) is 1.52 or less.

$$\text{M} \left[-\right] \text{=} \frac{\text{K}}{\text{π}} \frac{{\text{Q}}_{\text{a}}}{\text{L}} \frac{\text{1}}{\left({\text{T}}_{\text{w}} - {\text{T}}_{\text{a}}\right)} {\left(\frac{{\text{D}}_{\text{f}}}{{\text{D}}_{\text{n}}}\right)}^{\text{2}} \text{U} \qquad \text{(I)}$$

### TECHNICAL FIELD

The present invention relates to a method for manufacturing a fiber, for example, a plastic optical fiber.

### BACKGROUND ART

One known example of a method for manufacturing a fiber such as a plastic optical fiber (POF) is melt spinning. According to melt spinning, for example, a heated resin composition is sent to a nozzle, so that a softened linear body is discharged through the nozzle. The linear body is cooled to become solidified, and a fiber is thus produced.

In melt spinning, the cooling of the linear body is performed by, for example, bringing the linear body into contact with the cooling fluid. The cooling fluid used is, for example, a cooling airflow or water (Patent Literatures 1 and 2). By winding the linear body while bringing the linear body into contact with the cooling fluid, the linear body becomes solidified while being stretched, for example. Thus, a fiber having a desired outer diameter can be obtained.

### CITATION LIST

### Patent Literature

Patent Literature 1: JP 2009-186772 A
Patent Literature 2: JP 2006-163007 A

### SUMMARY OF INVENTION

### Technical Problem

In melt spinning, it is required that the variation in outer diameter of the fiber to be formed should be reduced. In view of this, the present invention aims to provide a fiber manufacturing method suitable for reducing the variation in outer diameter.

### Solution to Problem

As a result of intensive studies, the present inventors have newly found that the variation in outer diameter of the fiber is affected by a heat transfer that occurs during the cooling of the linear body between the linear body and the cooling fluid. On the basis of the finding, the present inventors have proceeded with the studies and derived a novel index M configured only with measurable parameters from the Nusselt number, which is an index of heat transfer, thus leading to the completion of the present invention.

The present invention provides a fiber manufacturing method including:
discharging a softened linear body through a nozzle; and
winding the linear body so that the linear body passes through a cooling portion supplied with a cooling fluid, thereby obtaining a fiber, wherein
the cooling portion has a filter configured to rectify the cooling fluid,
the cooling fluid in the cooling portion has a temperature that is substantially constant in a moving direction of the linear body, and
an index M determined by the following equation (I) is 1.52 or less
$$\text{M} \left[-\right] = \frac{\text{K}}{\text{π}} \frac{{\text{Q}}_{\text{a}}}{\text{L}} \frac{1}{( {\text{T}}_{\text{w}} - {\text{T}}_{\text{a}} )} {\left(\frac{{\text{D}}_{\text{f}}}{{\text{D}}_{\text{n}}}\right)}^{2} \text{U} \qquad \text{(I)}$$
where Qₐ is a flow rate (m³/s) of the cooling fluid to be supplied to the cooling portion,
L is a moving distance (m) of the linear body in the cooling portion,
T_{w} is a temperature (°C) of the linear body immediately after discharge through the nozzle,
Tₐ is a temperature (°C) of the cooling fluid,
D_{f} is an outer diameter (m) of the fiber,
Dₙ is an outer diameter (m) of the linear body immediately after the discharge through the nozzle,
U is a winding speed (m/s) for the linear body, and
K is 1.0 × 10⁸ (°C·s²/m³).

### Advantageous Effects of Invention

According to the present invention, it is possible to provide a fiber manufacturing method suitable for reducing the variation in outer diameter.

### BRIEF DESCRIPTION OF DRAWINGS

FIG. 1 is a diagram for explaining an example of a spinning apparatus for performing a manufacturing method of the present invention.

FIG. 2 is a diagram for explaining an example of a nozzle and a cooling portion included in the spinning apparatus.

FIG. 3 is a graph showing the relation between the index M and the ratio (3σ/Ave.) of a three-fold value of the standard deviation of the outer diameter of a fiber to the average value of the outer diameter of the fiber in Manufacturing Examples 1 to 15.

### DESCRIPTION OF EMBODIMENTS

Another aspect of the present invention provides a fiber manufacturing method including:
discharging a softened linear body through a nozzle; and
winding the linear body so that the linear body passes through a cooling portion supplied with a cooling fluid, thereby obtaining a fiber, wherein
an index M determined by the following equation (I) is 1.6 or less
$$\text{M} \left[-\right] = \frac{\text{K}}{\text{π}} \frac{{\text{Q}}_{\text{a}}}{\text{L}} \frac{1}{( {\text{T}}_{\text{w}} - {\text{T}}_{\text{a}} )} {\left(\frac{{\text{D}}_{\text{f}}}{{\text{D}}_{\text{n}}}\right)}^{2} \text{U} \qquad \text{(I)}$$
where Q₈ is a flow rate (m³/s) of the cooling fluid to be supplied to the cooling portion,
L is a moving distance (m) of the linear body in the cooling portion,
T_{w} is a temperature (°C) of the linear body immediately after discharge through the nozzle,
Tₐ is a temperature (°C) of the cooling fluid,
D_{f} is an outer diameter (m) of the fiber,
Dₙ is an outer diameter (m) of the linear body immediately after the discharge through the nozzle,
U is a winding speed (m/s) for the linear body, and
K is 1.0 × 10⁸ (°C·s²/m³).

An embodiment of the present invention will be described below. The following description is not intended to limit the present invention to a specific embodiment.

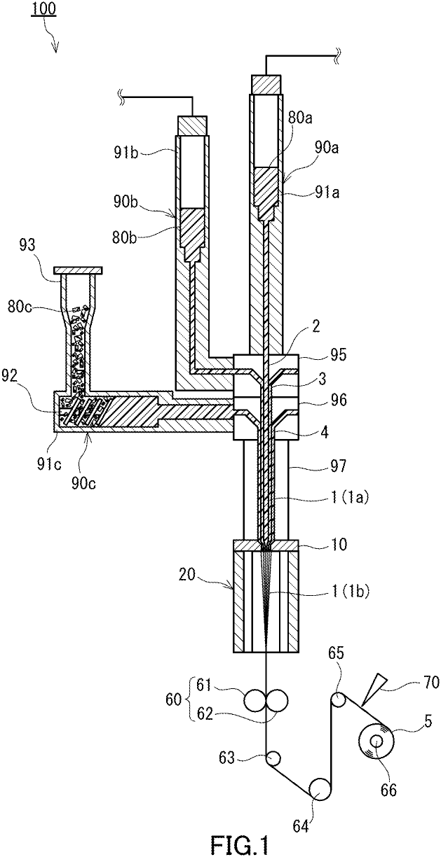

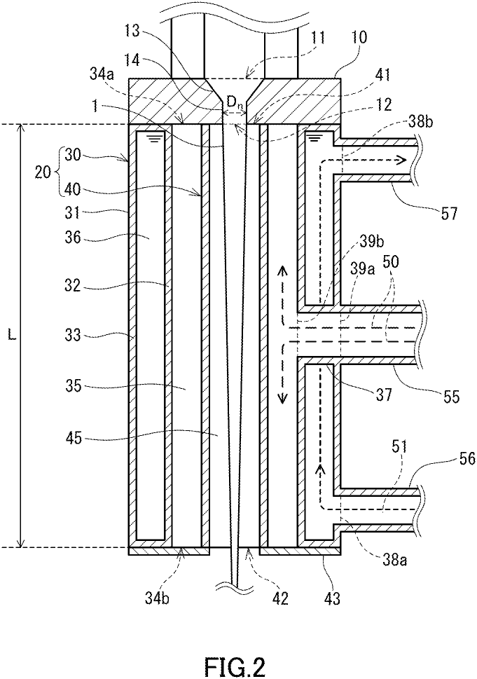

As shown in FIGS. 1 and 2, a manufacturing method of the present embodiment includes: discharging a softened linear body 1 through a nozzle 10; and winding the linear body 1 so that the linear body 1 passes through a cooling portion 20 supplied with a cooling fluid 50, thereby obtaining a fiber 5. The cooling portion 20 has a filter 40 configured to rectify the cooling fluid 50. The cooling fluid 50 in the cooling portion 20 has a temperature that is substantially constant in the moving direction of the linear body 1. Further, according to the manufacturing method of the present embodiment, the index M determined by the following equation (I) is 1.52 or less.

$$\text{M} \left[-\right] = \frac{\text{K}}{\text{π}} \frac{{\text{Q}}_{\text{a}}}{\text{L}} \frac{1}{( {\text{T}}_{\text{w}} - {\text{T}}_{\text{a}} )} {\left(\frac{{\text{D}}_{\text{f}}}{{\text{D}}_{\text{n}}}\right)}^{2} \text{U} \qquad \text{(I)}$$

In the equation (I), Qₐ is the flow rate (m³/s) of the cooling fluid 50 to be supplied to the cooling portion 20, L is the moving distance (m) of the linear body 1 in the cooling portion 20, T_{w} is the temperature (°C) of the linear body 1 immediately after the discharge through the nozzle 10, Tₐ is the temperature (°C) of the cooling fluid 50, D_{f} is the outer diameter (m) of the fiber 5, Dₙ is the outer diameter (m) of the linear body 1 immediately after the discharge through the nozzle 10, U is the winding speed (m/s) for the linear body 1, and K is the proportionality constant relating to the temperature for deriving the index M from the Nusselt number, and is 1.0 × 10⁸ (°C·s²/m³).

According to the manufacturing method of the present embodiment, the index M is preferably 1.2 or less, more preferably 1.0 or less, even more preferably 0.8 or less, and particularly preferably 0.5 or less. The index M is 0 or more, may be more than 0, and is, for example, 0.01 or more.

As described above, the index M is derived from the Nusselt number, which is an index of heat transfer. According to the studies by the present inventors, adjusting the manufacturing conditions so that the index M is 1.52 or less tends to be able to reduce the variation in outer diameter of the fiber 5. The variation in outer diameter of the fiber 5 can be evaluated by the ratio (3σ/Ave.) of a three-fold value (3σ) of the standard deviation of the outer diameter of the fiber 5 to the average value (Ave.) of the outer diameter of the fiber 5. The ratio 3σ/Ave. for the fiber 5 obtained by the manufacturing method of the present embodiment is not particularly limited, and is, for example, 2.0% or less, preferably 1.5% or less, more preferably 1.0% or less, and even more preferably 0.8% or less. The lower limit for the ratio 3σ/Ave. is not particularly limited, and is, for example, 0.2%. The outer diameter of the fiber 5 can be measured with a commercially available displacement meter. The average value and standard deviation of the outer diameter of the fiber 5 are the values calculated from the measured values of the outer diameter for at least 50 points of the fiber 5.

Further, the index M and 3σ/Ave. may satisfy at least one selected from the group consisting of the following formulae (II) and (III).

$$3 \text{σ} / \text{Ave} . \geq \text{M} - 0.5 \qquad \text{(II)}$$

$$3 \text{σ} / \text{Ave} . \leq \text{M} + 1 \qquad \text{(III)}$$

As long as the index M is 1.52 or less, the flow rate Qₐ of the cooling fluid 50 to be supplied to the cooling portion 20 is not particularly limited, and is, for example, 0 m³/s to 1.0 × 10⁻² m³/s, preferably more than 0 m³/s and 1.0 × 10⁻² m³/s or less, and more preferably 0.5 × 10⁻⁴ m³/s to 1.0 × 10⁻³ m³/s.

Similarly, the moving distance L of the linear body 1 in the cooling portion 20 is not particularly limited, and is, for example, 0.1 m to 2.0 m.

The temperature T_{w} of the linear body 1 immediately after the discharge through the nozzle 10 is not particularly limited, and is, for example, 100° C. or higher, preferably 150° C. to 300° C. The temperature Tₐ of the cooling fluid 50 is not particularly limited, and is, for example, 50° C. or lower, preferably 5° C. to 40° C.

The outer diameter Dr of the fiber 5 is not particularly limited, and is, for example, 1.0 × 10⁻⁵ m to 1.0 × 10⁻³m. The outer diameter D_{f} of the fiber 5 represents, specifically, the average value calculated from the measured values of the outer diameter for at least 50 points of the fiber 5. The outer diameter Dₙ of the linear body 1 immediately after the discharge through the nozzle 10 is not particularly limited, and is, for example, 1.0 × 10⁻⁴ m to 1.0 × 10⁻²m, preferably 1.0 × 10⁻³ m to 1.0 × 10⁻² m.

The winding speed U for the linear body 1 is not particularly limited, and is, for example, 0.05 m/s to 10 m/s, preferably 0.1 m/s to 5 m/s.

Next, an example of a spinning apparatus 100 for performing the manufacturing method of the present embodiment will be described with reference to FIGS. 1 and 2. In FIG. 2, hatching for the linear body 1 is omitted for explanatory convenience.

The nozzle 10 and the cooling portion 20 are members included in the spinning apparatus 100. The nozzle 10 is, for example, a tubular member whose internal space communicates with the outside at its first opening portion 11 on the upper side and at its second opening portion 12 on the lower side. The first opening portion 11 and the second opening portion 12 are each typically circular in plan view. The diameter of the second opening portion 12 may be equal to, smaller than, or larger than the diameter of the first opening portion 11. The second opening portion 12 corresponds to the opening of the nozzle 10 for discharging the linear body 1. In an embodiment in which the diameter of the second opening portion 12 is equal to or smaller than the diameter of the first opening portion 11, the outer diameter Dₙ in the above equation (I) is, for example, equal to the diameter of the second opening portion 12.

The nozzle 10 has, for example, a diameter-reducing portion 13 and a tubular portion 14. The tubular portion 14 is connected to the diameter-reducing portion 13 on the lower side of the diameter-reducing portion 13. In the nozzle 10, for example, the first opening portion 11 is formed at an end portion of the diameter-reducing portion 13, and the second opening portion 12 is formed at an end portion of the tubular portion 14. The diameter-reducing portion 13 has the shape of, for example, a truncated cone whose diameter is reduced from the first opening portion 11 toward the tubular portion 14. The shape of the tubular portion 14 is, for example, a cylindrical shape.

The material of the nozzle 10 is not particularly limited, and is a metal, a resin, or the like.

According to the manufacturing method of the present embodiment, the softened linear body 1 is supplied to the first opening portion 11 of the nozzle 10, for example. The linear body 1 passes through the diameter-reducing portion 13 and the tubular portion 14, and is discharged through the second opening portion 12. In the present description, the linear body to be supplied to the first opening portion 11 is referred to also as “linear body 1a”, and the linear body to be discharged through the second opening portion 12 is referred to also as “linear body 1b”. Note that the first opening portion 11 may be supplied with not the linear body 1a but a molten resin, a viscous liquid, or the like. Even in this case, the molten resin, the viscous liquid, or the like is formed into a fibrous shape through the nozzle 10. Consequently, the linear body 1b is discharged through the second opening portion 12.

The linear body 1a supplied to the first opening portion 11 is reduced in outer diameter by passing through the diameter-reducing portion 13, for example. That is, the linear body 1b after the discharge through the nozzle 10 has a smaller outer diameter than the linear body 1a before the supply to the nozzle 10. The linear body 1b immediately after the discharge through the second opening portion 12 usually has an outer diameter equal to the diameter of the second opening portion 12. The linear body 1 is discharged through the nozzle 10 typically while being brought into contact with the circumferential edge of the second opening portion 12. Accordingly, the temperature of the nozzle 10 near the second opening portion 12 may be regarded as the temperature T_{w} in the above equation (I).

The cooling portion 20 has, for example, a tubular cooling pipe 30. The shape of the cooling pipe 30 is, for example, a cylindrical shape. The cooling pipe 30 has an internal space 35 (especially an internal space 45 of the filter 40, corresponding to a portion of the internal space 35, described later) that communicates with the outside at its first opening portion 34a on the upper side and at its second opening portion 34b on the lower side. The cooling pipe 30 is connected to the nozzle 10 and extends downward from the nozzle 10, for example. The first opening portion 34a of the cooling pipe 30 surrounds the second opening portion 12 of the nozzle 10, for example.

The cooling pipe 30 has, for example, a body portion 31 and a tubular portion 37. The body portion 31 includes an inner wall 32, an outer wall 33, and a containing space 36 positioned between the inner wall 32 and the outer wall 33. The inner wall 32 and the outer wall 33 are each tubular, preferably cylindrical. The inner wall 32 and the outer wall 33 each do not necessarily to be cylindrical, and may be, for example, in the shape of a rectangular cylinder. The inner wall 32 and the outer wall 33 each extend from the first opening portion 34a to the second opening portion 34b. The space surrounded by the inner wall 32 corresponds to the internal space 35 of the cooling pipe 30.

Into the containing space 36, a refrigerant 51 is introduced for cooling the cooling fluid 50 supplied to the internal space 35 of the cooling pipe 30, for example. Specifically, in the outer wall 33, a first opening portion 38a is formed near the second opening portion 34b of the cooling pipe 30, for example. The first opening portion 38a is, for example, connected to a refrigerant supply path 56 for supplying the refrigerant 51 to the containing space 36, thus functioning as the refrigerant inlet. The refrigerant 51 can be introduced into the containing space 36 through the first opening portion 38a. Further, in the outer wall 33, a second opening portion 38b may be formed near the first opening portion 34a of the cooling pipe 30. The second opening portion 38b is, for example, connected to a refrigerant release path 57 for releasing the refrigerant 51 from the containing space 36, thus functioning as the refrigerant outlet. In the present embodiment, the refrigerant release path 57 may be connected to the refrigerant supply path 56 via the containing space 36 so that the refrigerant 51 circulates through the refrigerant supply path 56, the containing space 36, and the refrigerant release path 57. In FIG. 2, the state is shown in which the refrigerant 51 moves upward in the containing space 36. Alternatively, the cooling pipe 30 may be configured in such a manner that the refrigerant 51 moves downward in the containing space 36. That is, the second opening portion 38b formed in the outer wall 33 may function as the refrigerant inlet, and the first opening portion 38a formed in the outer wall 33 may function as the refrigerant outlet.

The tubular portion 37 is a tubular member protruding through the body portion 31 in the direction from the inner wall 32 toward the outer wall 33. The tubular portion 37 extends, for example, in a direction orthogonal to the extending direction of the inner wall 32. In an end portion of the tubular portion 37 adjacent to the outer wall 33, a first opening portion 39a is formed. In an end portion of the tubular portion 37 adjacent to the inner wall 32, a second opening portion 39b is formed. The first opening portion 39a is, for example, connected to a cooling fluid supply path 55 for supplying the cooling fluid 50 into the tubular portion 37, thus functioning as the cooling fluid inlet. The cooling fluid 50 sent into the tubular portion 37 is supplied to the internal space 35 of the cooling pipe 30 through the second opening portion 39b. In the tubular portion 37, a flowmeter is disposed for measuring the flow rate Q_{B} of the cooling fluid 50 to be supplied to the internal space 35, for example.

The position of the tubular portion 37 is not particularly limited as long as the cooling fluid 50 can be sufficiently supplied to the internal space 35 of the cooling pipe 30. For example, the distance between the tubular portion 37 and the first opening portion 34a of the cooling pipe 30 may or may not be equal to the distance between the tubular portion 37 and the second opening portion 34b of the cooling pipe 30. In FIG. 2, the tubular portion 37 is positioned near the center in the longitudinal direction of the cooling pipe 30. Alternatively, the tubular portion 37 may be positioned near an end portion (upper portion or lower portion) of the cooling pipe 30. Further, in FIG. 2, the one cooling fluid supply path 55 is connected to the one tubular portion 37. Alternatively, in the present embodiment, the cooling pipe 30 may have the plurality of tubular portions 37, and accordingly the plurality of cooling fluid supply paths 55 may be connected to the plurality of tubular portions 37 on a one-to-one basis.

As described above, the cooling portion 20 has the filter 40 configured to rectify the cooling fluid 50. The filter 40 is, for example, tubular, preferably cylindrical. The filter 40 is composed of, for example, a nonwoven fabric, a woven fabric, or a mesh, and is permeable to the cooling fluid 50. The filter 40 is positioned in the internal space 35 of the cooling pipe 30 and extends in the same direction as the cooling pipe 30, for example. The length of the filter 40 may be equal to or different from the length of the cooling pipe 30. The filter 40 has the internal space 45 that communicates with the outside at its first opening portion 41 on the upper side and at its second opening portion 42 on the lower side. The internal space 45 of the filter 40 can be regarded as a portion of the internal space 35 of the cooling pipe 30. Similarly, the opening portions 41 and 42 of the filter 40 can be regarded as respective portions of the opening portion 34a and the opening portion 34b of the cooling pipe 30 as well. The filter 40 is, for example, connected to the nozzle 10. The first opening portion 41 of the filter 40 surrounds the second opening portion 12 of the nozzle 10, for example. The diameter of the second opening portion 42 of the filter 40 may be equal to or different from the inner diameter of the filter 40.

The cooling portion 20 may have, instead of the filter 40, a tubular wall portion impermeable to the cooling fluid 50. The shape of the tubular wall portion is, for example, the same as that exemplified for the filter 40. In the case where the cooling portion 20 has a tubular wall portion, the linear body 1 is out of direct contact with the cooling fluid 50. Even in such an embodiment, the cooling pipe 30 can reduce disturbance due to air existing outside. Via the tubular wall portion, the cooling fluid 50 can also exchange heat with air existing in the internal space surrounded by the wall portion. Even in the case where the linear body 1 is out of direct contact with the cooling fluid 50, the index M can be used as the index for reducing the variation in outer diameter of the fiber 5.

For example, the cooling portion 20 further has a lid 43 that closes a portion of the second opening portion 34b of the cooling pipe 30 except for the second opening portion 42 of the filter 40. The lid 43 is connected to each of the end portion of the cooling pipe 30 and the end portion of the filter 40, for example. The lid 43 may further close a portion of the second opening portion 42 of the filter 40 as long as the lid 43 is out of contact with the linear body 1. The lid 43 may be integrated with the cooling pipe 30. With the lid 43, emission of the cooling fluid 50 to the outside of the cooling pipe 30 with no contact with the linear body 1 can be reduced, for example.

In the present embodiment, the cooling fluid 50 is, for example, a gas. The cooling fluid 50 in gas form is air, an inert gas such as helium, or the like, preferably air. The refrigerant 51 can be, for example, a liquid such as water. The temperature of the refrigerant 51 is not particularly limited, and is, for example, 20° C. or lower.

The material of each of the body portion 31 and the tubular portion 37 of the cooling pipe 30 is not particularly limited, and is glass, a metal, or the like. The material of the filter 40 is not particularly limited, and is, for example, a metal or a resin.

According to the manufacturing method of the present embodiment, the cooling fluid 50 is sent to the internal space 35 of the cooling pipe 30 through the tubular portion 37. The cooling fluid 50 sent to the internal space 35 fills the internal space 35. In the case where the cooling portion 20 has the lid 43, the cooling fluid 50 is emitted to the outside through the portion, which is not closed with the lid 43, of the second opening portion 34b of the cooling pipe 30. Alternatively, the cooling portion 20 may not have the lid 43, and accordingly the entire second opening portion 34b of the cooling pipe 30 may be exposed to the outside of the cooling portion 20. In this case, the cooling fluid 50 is emitted to the outside through the entire second opening portion 34b. Further, the nozzle 10 and the cooling pipe 30 may have a gap therebetween so that the cooling fluid 50 is emitted through the first opening portion 34a of the cooling pipe 30 as well. In the case where the cooling portion 20 has the filter 40, the cooling fluid 50 permeates the filter 40 to fill the internal space 45 as well. The cooling fluid 50 is rectified by permeating the filter 40.

The linear body 1 discharged through the second opening portion 12 of the nozzle 10 is introduced into the internal space 35 of the cooling pipe 30 (or the internal space 45 of the filter 40) through the first opening portion 34a of the cooling pipe 30 (or the first opening portion 41 of the filter 40). The linear body 1 introduced into the internal space 35 or 45 is brought into contact with the cooling fluid 50. In this way, according to the manufacturing method of the present embodiment, the linear body 1 is cooled in the cooling portion 20 by being brought into contact with the cooling fluid 50. Along with the cooling by the cooling fluid 50, the linear body 1 gradually becomes solidified. In the case where the cooling fluid 50 is rectified by the filter 40, the linear body 1 can be brought into uniform contact with the cooling fluid 50. Uniform contact of the linear body 1 with the cooling fluid 50 tends to further reduce the variation in outer diameter of the resultant fiber 5. The filter 40 can reduce a direct spray of the cooling fluid 50 in an unrectified state, which has been sent to the internal space 35 of the cooling pipe 30, onto the linear body 1.

The linear body 1 passes through the internal space 35 or 45 while being cooled, and is sent to the second opening portion 34b of the cooling pipe 30 (or the second opening portion 42 of the filter 40). In FIG. 2, the linear body 1 moves in the internal space 35 along the extending direction of the cooling pipe 30. In this embodiment, the moving distance L of the linear body 1 in the cooling portion 20 is equal to the length of the cooling pipe 30.

The linear body 1 gradually becomes stretched in the cooling portion 20. This gradually reduces the outer diameter of the linear body 1 as the linear body 1 passes through the cooling portion 20, for example.

The cooling fluid 50 supplied to the internal space 35 exchanges heat with the refrigerant 51 via the inner wall 32 of the cooling pipe 30, and exchanges heat with the linear body 1 passing through the internal space 35 as well. Consequently, a temperature gradient for the cooling fluid 50 occurs near the inner wall 32 and near the linear body 1. Note that, at a position in the internal space 35 away from the inner wall 32 and the linear body 1, a temperature gradient for the cooling fluid 50 hardly occurs. The temperature Tₐ in the above equation (I) represents the temperature of the cooling fluid 50 at a position in the internal space 35 where the temperature gradient of the cooling fluid 50 hardly occurs. In an example, the temperature Tₐ in the equation (I) may be the temperature of the cooling fluid 50 near the filter 40. The temperature of the cooling fluid 50 near the filter 40 is, for example, substantially constant in the extending direction of the filter 40 (i.e., the moving direction of the linear body 1). In other words, the temperature of the cooling fluid 50 permeating the filter 40 is substantially uniform.

The cooling portion 20 is not limited to the above, and may have, for example, a storage tank in which a cooling fluid in liquid form can be stored instead of the cooling pipe 30. The cooling fluid in liquid form is, for example, water. In this case, the storage tank of the cooling portion 20 has, for example, a cooling fluid inlet for introducing the cooling fluid into the storage tank and a cooling fluid outlet for releasing the cooling fluid to the outside. The linear body 1 discharged through the nozzle 10 is wound, for example, so as to pass through the storage tank.

To produce the linear body 1a to be supplied to the nozzle 10, the spinning apparatus 100 further includes, for example, a first extruder 90a, a second extruder 90b, a third extruder 90c, a first chamber 95, a second chamber 96, and a third chamber 97 as shown in FIG. 1. The first chamber 95, the second chamber 96, and the third chamber 97 are arranged in this order downward in the vertical direction. The third chamber 97 is connected to the nozzle 10.

The first extruder 90a has a containing portion 91a that contains a first resin composition 80a, and can introduce a gas into the containing portion 91a to extrude the first resin composition 80a from the containing portion 91a. The first extruder 90a includes, for example, a heater (not illustrated) for heating the first resin composition 80a contained in the containing portion 91a. The first resin composition 80a softens to become flowable by, for example, being heated. The gas introduced into the containing portion 91a presses the upper surface of the softened first resin composition 80a, thus extruding the first resin composition 80a from the first extruder 90a. The gas to be sent to the containing portion 91a is preferably an inert gas such as a nitrogen gas. The heating temperature for the first resin composition 80a can be appropriately set according to the composition of the first resin composition 80a, and is, for example, 100° C. to 300° C. A viscosity µ of the first resin composition 80a extruded from the first extruder 90a is not particularly limited, and is, for example, 1 to 7000 Pa·s.

The first resin composition 80a extruded from the first extruder 90a moves downward in the vertical direction, and is formed into a fibrous shaped body (core 2), for example. That is, the manufacturing method of the present embodiment further includes, for example, extruding the first resin composition 80a with the first extruder 90a to form the core 2. The core 2 is sent from the first extruder 90a to the first chamber 95.

The first resin composition 80a preferably has a composition suitable for the core of the POF. The first resin composition 80a includes, for example, a fluorine-containing polymer (polymer (P)). From the viewpoint of reducing light absorption attributable to the stretching energy of the C—H bond, it is preferable that the polymer (P) should be substantially free of a hydrogen atom, and it is particularly preferable that every hydrogen atom bonded to a carbon atom in the polymer (P) should be substituted by a fluorine atom. The phrase “the polymer (P) is substantially free of a hydrogen atom” as used herein means that the hydrogen atom content in the polymer (P) is 1 mol% or less.

The polymer (P) preferably has a fluorine-containing aliphatic ring structure. The fluorine-containing aliphatic ring structure may be included in a principal chain of the polymer (P) or in a side chain of the polymer (P). The polymer (P) has, for example, a structural unit (A) represented by the following formula (1).

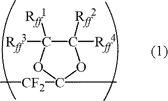

In the formula (1), R_{ff}¹ to R_{ff}⁴ each independently represent a fluorine atom, a perfluoroalkyl group having 1 to 7 carbon atoms, or a perfluoroalkyl ether group having 1 to 7 carbon atoms. R_{ff}¹ and R_{ff}² are optionally linked to form a ring. The term “perfluoro” indicates that every hydrogen atom bonded to a carbon atom is substituted by a fluorine atom. In the formula (1), the number of carbon atoms in the perfluoroalkyl group is preferably 1 to 5, more preferably 1 to 3, and even more preferably 1. The perfluoroalkyl group may be linear or branched. Examples of the perfluoroalkyl group include a trifluoromethyl group, a pentafluoroethyl group, and a heptafluoropropyl group.

In the formula (1), the number of carbon atoms in the perfluoroalkyl ether group is preferably 1 to 5 and more preferably 1 to 3. The perfluoroalkyl ether group may be linear or branched. Examples of the perfluoroalkyl ether group include a perfluoromethoxymethyl group.

When R_{ff}¹ and R_{ff}² are linked to form a ring, the ring may be a five-membered ring or a six-membered ring. Examples of the ring include a perfluorotetrahydrofuran ring, a perfluorocyclopentane ring, and a perfluorocyclohexane ring.

Specific examples of the structural unit (A) include structural units represented by the following formulae (A1) to (A8).

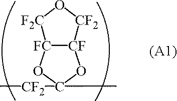

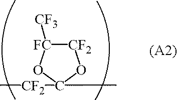

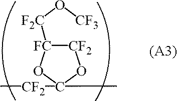

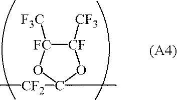

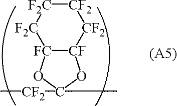

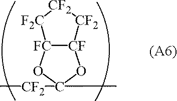

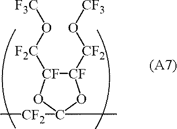

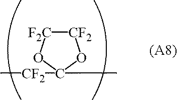

Among the structural units represented by the above formulae (A1) to (A8), the structural unit (A) is preferably the structural unit (A2), i.e., a structural unit represented by the following formula (2).

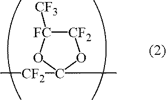

The polymer (P) may include one or more structural units (A). In the polymer (P), the content of the structural unit (A) is preferably 20 mol% or more and more preferably 40 mol% or more in the total of the contents of all the structural units. When including 20 mol% or more of the structural unit (A), the polymer (P) tends to have much higher thermal resistance. When including 40 mol% or more of the structural unit (A), the polymer (P) tends to have much higher transparency and much higher mechanical strength in addition to high thermal resistance. In the polymer (P), the content of the structural unit (A) is preferably 95 mol% or less and more preferably 70 mol% or less in the total of the contents of all the structural units.

The structural unit (A) is derived from, for example, a compound represented by the following formula (3). In the formula (3), R_{ff}¹ to R_{ff}⁴ are as described in the formula (1). The compound represented by the formula (3) can be obtained by a known manufacturing method, such as the manufacturing method disclosed in JP 2007-504125 A.

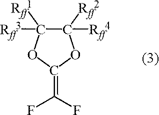

Specific examples of the compound represented by the above the formula (3) include compounds represented by the following formulae (M1) to (M8).

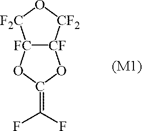

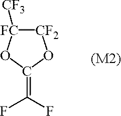

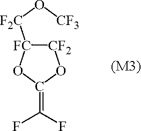

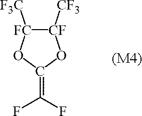

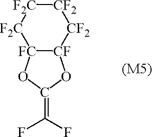

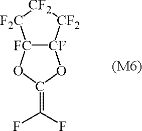

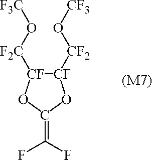

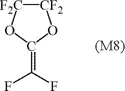 [SMILES: FC(F)=C1OC(F)(F)C(F)(F)O1]

The polymer (P) may further include an additional structural unit other than the structural unit (A). Examples of the additional structural unit include the following structural units (B) to (D).

The structural unit (B) is represented by the following formula (4).

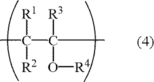

In the formula (4), R¹ to R³ each independently represent a fluorine atom or a perfluoroalkyl group having 1 to 7 carbon atoms. R⁴ represents a perfluoroalkyl group having 1 to 7 carbon atoms. The perfluoroalkyl group may have a ring structure. One or some of the fluorine atoms represented by R¹ to R³ may each be substituted by a halogen atom other than a fluorine atom. One or some of fluorine atoms in the perfluoroalkyl group may each be substituted by a halogen atom other than a fluorine atom.

The polymer (P) may include one or more structural units (B). In the polymer (P), the content of the structural unit (B) is preferably 5 to 10 mol% in the total of the contents of all the structural units. The content of the structural unit (B) may be 9 mol% or less or 8 mol% or less.

The structural unit (B) is derived from, for example, a compound represented by the following formula (5). In the formula (5), R¹ to R⁴ are as described in the formula (4). The compound represented by the formula (5) is a fluorine-containing vinyl ether such as perfluorovinyl ether.

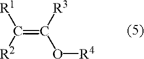

The structural unit (C) is represented by the following formula (6).

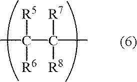

In the formula (6), R⁵ to R⁸ each independently represent a fluorine atom or a perfluoroalkyl group having 1 to 7 carbon atoms. The perfluoroalkyl group may have a ring structure. One or some of the fluorine atoms represented by R⁵ to R⁸ may each be substituted by a halogen atom other than a fluorine atom. One or some of fluorine atoms in the perfluoroalkyl group may each be substituted by a halogen atom other than a fluorine atom.

The polymer (P) may include one or more structural units (C). In the polymer (P), the content of the structural unit (C) is preferably 5 to 10 mol% in the total of the contents of all the structural units. The content of the structural unit (C) may be 9 mol% or less or 8 mol% or less.

The structural unit (C) is derived from, for example, a compound represented by the following formula (7). In the formula (7), R⁵ to R⁸ are as described in the formula (6). The compound represented by the formula (7) is a fluorine-containing olefin such as tetrafluoroethylene and chlorotrifluoroethylene.

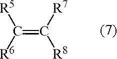

The structural unit (D) is represented by the following formula (8).

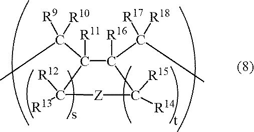

In the formula (8), Z represents an oxygen atom, a single bond, or —OC(R¹⁹R²⁰)O—, R⁹ to R²⁰ each independently represent a fluorine atom, a perfluoroalkyl group having 1 to 5 carbon atoms, or a perfluoroalkoxy group having 1 to 5 carbon atoms. One or some of the fluorine atoms represented by R⁹ to R²⁰ may each be substituted by a halogen atom other than a fluorine atom. One or some of fluorine atoms in the perfluoroalkyl group may each be substituted by a halogen atom other than a fluorine atom. One or some of fluorine atoms in the perfluoroalkoxy group may each be substituted by a halogen atom other than a fluorine atom. The symbols s and t are each independently 0 to 5, and s + t represents an integer of 1 to 6 (when Z is —OC(R¹⁹R²⁰)O—, s + t may be 0).

The structural unit (D) is preferably represented by the following formula (9). The structural unit represented by the following formula (9) is a structural unit represented by the above formula (8), where Z is an oxygen atom, s is 0, and t is 2.

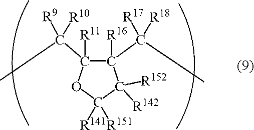

In the formula (9), R¹⁴¹, R¹⁴², R¹⁵¹, and R¹⁵² each independently represent a fluorine atom, a perfluoroalkyl group having 1 to 5 carbon atoms, or a perfluoroalkoxy group having 1 to 5 carbon atoms. One or some of the fluorine atoms represented by R¹⁴¹, R^{142,} R¹⁵¹, and R¹⁵² may each be substituted by a halogen atom other than a fluorine atom. One or some of fluorine atoms in the perfluoroalkyl group may each be substituted by a halogen atom other than a fluorine atom. One or some of fluorine atoms in the perfluoroalkoxy group may each be substituted by a halogen atom other than a fluorine atom.

The polymer (P) may include one or more structural units (D). In the polymer (P), the content of the structural unit (D) is preferably 30 to 67 mol% in the total of the contents of all the structural units. The content of the structural unit (D) is, for example, 35 mol% or more, and may be 60 mol% or less or 55 mol% or less.

The structural unit (D) is derived from, for example, a compound represented by the following formula (10). In the formula (10), Z, R⁹ to R¹⁸, s, and t are as described in the formula (8). The compound represented by the formula (10) is a fluorine-containing compound having two or more polymerizable double bonds and being cyclopolymerizable.

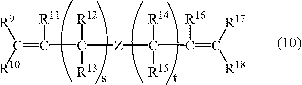

The structural unit (D) is preferably derived from a compound represented by the following formula (11). In the formula (11), R¹⁴¹, R¹⁴², R¹⁵¹, and R¹⁵² are as described in the formula (9).

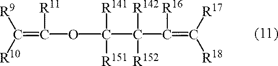

Specific examples of the compound represented by the formula (10) or the formula (11) include the following compounds.
CF₂=CFOCF₂CF=CF₂
CF₂=CFOCF(CF₃)CF=CF₂
CF₂=CFOCF₂CF₂CF=CF₂
CF₂=CFOCF₂CF(CF₃)CF=CF₂
CF₂=CFOCF(CF₃)CF₂CF=CF₂
CF₂=CFOCFCICF₂CF=CF₂
CF₂=CFOCCI₂CF₂CF=CF₂
CF₂=CFOCF2OCF=CF₂
CF₂=CFOC(CF₃)20CF=CF₂
CF₂=CFOCF₂CF(OCF₃)CF=CF₂
CF₂=CFCF₂CF=CF₂
CF₂=CFCF₂CF₂CF=CF₂
CF₂=CFCF₂OCF₂CF=CF₂
CF₂=CFOCF₂CFCICF=CF₂
CF₂=CFOCF₂CF₂CCI=CF₂
CF₂=CFOCF₂CF₂CF=CFCI
CF₂=CFOCF₂CF(CF₃)CCI=CF₂
CF₂=CFOCF₂OCF=CF₂
CF₂=CFOCCl₂OCF=CF₂
CF₂=CCIOCF₂OCCl=CF₂

The polymer (P) may further include an additional structural unit other than the structural units (A) to (D), but is preferably substantially free of an additional structural unit other than the structural units (A) to (D). The phrase “the polymer (P) is substantially free of an additional structural unit other than the structural units (A) to (D)” means that the sum of the contents of the structural units (A) to (D) is 95 mol% or more and preferably 98 mol% or more in the total of the contents of all the structural units in the polymer (P).

The method for polymerizing the polymer (P) is not particularly limited and a common polymerization method, such as radical polymerization, can be used. The polymerization initiator for polymerizing the polymer (P) may be a fully fluorinated compound.

The glass transition temperature (Tg) of the polymer (P) is not particularly limited, and is, for example, 100° C. to 140° C., and may be 105° C. or higher or 120° C. or higher. The sign “Tg” as used herein represents the midpoint glass transition temperature (T_{mg}) determined according to JIS K 7121: 1987.

The first resin composition 80a may include the polymer (P) as a main component, and preferably consists substantially of the polymer (P). The first resin composition 80a may further include an additive such as a refractive index modifier. The first resin composition 80a is, for example, solid at ordinary temperature (25° C.).

The second extruder 90b includes, for example, a containing portion 91b that contains a second resin composition 80b having a composition suitable for the clad of the POF. The second extruder 90b can be the above described for the first extruder 90a. The second extruder 90b can introduce a gas into the containing portion 91b to extrude the second resin composition 80b from the containing portion 91b.

The second resin composition 80b extruded from the second extruder 90b is supplied to the first chamber 95. In the first chamber 95, by coating the core 2 with the second resin composition 80b, it is possible to form a clad 3 disposed on the outer circumference of the core 2 and coating the outer circumference. The core 2, which is coated with the clad 3, moves from the first chamber 95 to the second chamber 96. In this way, the manufacturing method of the present embodiment further includes, for example, coating the side of the core 2 with the second resin composition 80b that is different from the first resin composition 80a constituting the core 2.

In the case where the fiber 5 is used as the POF, the second resin composition 80b constituting the clad 3 preferably has a lower refractive index than the first resin composition 80a constituting the core 2. The resin material included in the second resin composition 80b is, for example, a fluorine-containing resin, an acrylic resin such as methyl methacrylate, a styrene resin, or a carbonate resin.

The third extruder 90c includes, for example, a containing portion 91c that contains a third resin composition 80c having a composition suitable for the coating layer (overclad) of the POF, a screw 92 disposed in the containing portion 91c, and a hopper 93 connected to the containing portion 91c. The third extruder 90c includes, for example, a heater (not illustrated) for heating the third resin composition 80c. In the third extruder 90c, the third resin composition 80c in a pellet form is supplied to the containing portion 91c through the hopper 93. The third resin composition 80c in a pellet form supplied to the containing portion 91c softens to become flowable by, for example, being kneaded by the screw 92 while being heated. The softened third resin composition 80c is extruded from the containing portion 91c by the screw 92.

The third resin composition 80c extruded from the third extruder 90c is supplied to the second chamber 96. In the second chamber 96, by coating the clad 3 with the third resin composition 80c, it is possible to form a coating layer 4 coating the outer circumference of the clad 3. Thus, the linear body 1a having the core 2, the clad 3, and the coating layer 4 is obtained. The linear body 1a moves from the second chamber 96 to the third chamber 97.

Examples of the resin material included in the third resin composition 80c constituting the coating layer 4 include a polyester such as polyethylene terephthalate and polyethylene naphthalate, polyethersulfone, polycarbonate, various engineering plastics, a cycloolefin polymer, PTFE, modified PTFE, and PFA.

The linear body 1a passes through the third chamber 97 and is sent to the first opening portion 11 of the nozzle 10. In the third chamber 97, a heater (not illustrated) for heating the linear body 1a may be disposed. In the third chamber 97, for example, the temperature and viscosity of the linear body 1a are appropriately adjusted. In the third chamber 97, the linear body 1a may be heated to diffuse the refractive index modifier included in the first resin composition 80a into the linear body 1a.

The linear body 1a used in the present embodiment is a shaped body with a three-layer structure including the core 2, the clad 3, and the coating layer 4. However, the structure of the linear body 1a is not limited to the three-layer structure. The structure of the linear body 1a may be a two-layer structure composed of the core 2 and the clad 3 or a single-layer structure composed of the core 2.

As shown in FIG. 1, the spinning apparatus 100 further includes, for example, a nip roll 60, guide rolls 63, 64, and 65, and a winding roll 66 to convey and wind the linear body 1b discharged through the nozzle 10. The nip roll 60 is positioned, for example, below the cooling portion 20. The linear body 1 passed through the cooling portion 20 passes, for example, between two rolls 61 and 62 of the nip roll 60.

The guide rolls 63, 64, and 65 are arranged in this order in the conveying direction for the linear body 1. The linear body 1 passed through the nip roll 60 is wound around the winding roll 66 via the guide rolls 63, 64, and 65, thereby obtaining the fiber 5. The winding speed U in the above equation (I) can be calculated from the rotation speeds of the winding roll 66, the nip roll 60, and the like.

The spinning apparatus 100 may further include a displacement meter 70 near the winding roll 66, for example, between the guide roll 65 and the winding roll 66. The displacement meter 70 is for measuring the outer diameter of the linear body 1. The outer diameter of the linear body 1 measured by the displacement meter 70 may be regarded as the outer diameter of the fiber 5. According to the manufacturing method of the present embodiment, the linear body 1 is sufficiently cooled in the cooling portion 20. This leads to a tendency for the temperature of the linear body 1 to be almost unvaried and for the outer diameter of the linear body 1 to be almost unvaried as well until the linear body 1 is wound around the winding roll 66 after the passage through the cooling portion 20. In other words, according to the manufacturing method of the present embodiment, the outer diameter of the fiber 5 is substantially equal to the outer diameter of the linear body 1 immediately after the passage through the cooling portion 20.

The spinning apparatus 100 may further include a controller (not illustrated) in which a program for appropriately operating the spinning apparatus 100 is stored. For example, the controller may control the driving of the rolls, and may control the heaters disposed in the extruders.

The fiber 5 produced by the manufacturing method of the present embodiment is preferably a POF. However, the fiber 5 may be used for applications other than the POF. For example, the fiber 5 may be used as the yarn to be woven into a membrane, a nonwoven fabric, and the like. The manufacturing method of the present embodiment can also be used as a method for manufacturing a fiber including a material other than the resin composition (e.g., glass).

### Examples

The present invention will be described below in more detail with reference to examples and comparative examples. The present invention is not limited to these examples.

### (Manufacturing Examples 1 to 15)

In Manufacturing Examples 1 to 15, fiber manufacture was performed with the nozzle and the cooling portion under the conditions described in Table 1. Specifically, a resin composition composed of polycarbonate was extruded from the extruder to form a core. The core was introduced as the linear body into the nozzle. The cooling portion had a cooling pipe connected to the nozzle and extending downward from the nozzle and a tubular filter positioned in the internal space of the cooling pipe and configured to rectify the cooling fluid. In the internal space of the cooling pipe, the linear body discharged through the nozzle was cooled by being brought into contact with the cooling fluid. The internal space of the cooling pipe was supplied with air as the cooling fluid. The containing space of the cooling pipe was supplied with water as the refrigerant. The outer diameter of the linear body immediately after the discharge through the nozzle was equal to the diameter of the opening of the nozzle for discharging the linear body.

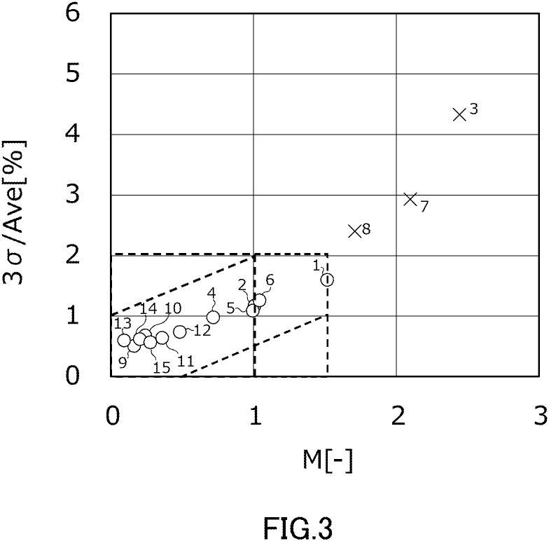

The outer diameter of the linear body was measured near the winding roll with a displacement meter (LS-9006M manufactured by Keyence Corporation), and the obtained measured value was regarded as the outer diameter of the fiber. The measurement cycle for the outer diameter was 0.1 seconds, and the number of measurement points for the outer diameter was 500. On the basis of the obtained results, the ratio 3σ/Ave. was calculated. The relation between the index M and the ratio 3σ/Ave. is shown in Table 1 and FIG. 3.

TABLE 1

| | | | | | | | | | | | | | | | |
|---|---|---|---|---|---|---|---|---|---|---|---|---|---|---|---|
| Manufacturing Example | 1 | 2 | 3 | 4 | 5 | 6 | 7 | 8 | 9 | 10 | 11 | 12 | 13 | 14 | 15 |
| Flow rate of cooling fluid Qₐ [m³/s] | 5.00×10⁻⁴ | 3.33×10⁻⁴ | 8.33×10⁻⁴ | 2.33×10⁻⁴ | 3.33×10⁻⁴ | 3.33×10⁻⁴ | 3.33×10⁻⁴ | 3.33×10⁻⁴ | 1.73×10⁻⁴ | 1.73×10⁻⁴ | 1.72×10⁻⁴ | 1.70×10⁻⁴ | 1.77×10⁻⁴ | 1.72×10⁻⁴ | 1.72×10⁻⁴ |
| Moving distance L [m] | 0.8 | 0.8 | 0.8 | 0.8 | 0.8 | 0.8 | 0.8 | 0.8 | 0.8 | 0.8 | 0.8 | 0.8 | 0.8 | 0.8 | 0.8 |
| Temperature of linear body T_{w}[°C) | 230 | 230 | 230 | 230 | 230 | 230 | 230 | 220 | 230 | 230 | 230 | 230 | 230 | 230 | 230 |
| Temperature of cooling fluid Tₐ[°C) | 23.6 | 26.5 | 19.2 | 281 | 23.4 | 31.6 | 34.4 | 25.9 | 29.9 | 26.4 | 29.1 | 32.25 | 30.1 | 30.3 | 33.8 |
| Outer diameter of fiber D_{f}[m] | 2.62×10⁻⁴ | 2.60×10⁻⁴ | 2.60×10⁻⁴ | 2.61×10⁻⁴ | 2.60×10⁻⁴ | 2.61×10⁻⁴ | 2.60×10⁻⁴ | 4.90×10⁻⁴ | 4.93×10⁻⁴ | 2.65×10⁻⁴ | 2.63×10⁻⁴ | 2.64×10⁻⁴ | 4.90×10⁻⁴ | 2.68×10⁻⁴ | 2.68×10⁻⁴ |
| Outer diameter of linear body Dₙ[m] | 2.00×10⁻³ | 2.00×10⁻³ | 2.00×10⁻³ | 2 00×10⁻³ | 2.00×10⁻³ | 2.00×10⁻³ | 2.00×10⁻³ | 2.00×10⁻³ | 3.00×10⁻³ | 3.00×10⁻³ | 3.00×10⁻³ | 3.00×10⁻³ | 4.00×10⁻³ | 4.00×10⁻³ | 4.00×10⁻³ |
| Winding speed U [m/s] | 0.92 | 0.92 | 0.92 | 0.92 | 0.92 | 0.92 | 1.83 | 0.42 | 0.18 | 0.92 | 1.38 | 1.83 | 0.18 | 1.33 | 1.77 |
| Index M [-] | 1.62 | 1.01 | 2.44 | 0.72 | 0.99 | 1.04 | 2.10 | 1.71 | 0.16 | 0.24 | 0.36 | 0.48 | 0.09 | 0.20 | 0.28 |
| Ratio 3a/Ave. [%] | 1.80 | 1.17 | 4.33 | 0.98 | 1.09 | 128 | 2.93 | 2.40 | 0.51 | 0.88 | 0.84 | 0.74 | 0.80 | 0.82 | 0.57 |

As can be seen from Table 1 and FIG. 3, in Manufacturing Examples 1, 2, 4 to 6, and 9 to 15 in which the index M was 1.52 or less, the value of the ratio (3σ/Ave.) was small and the variation in outer diameter of the fiber was reduced, compared with those in Manufacturing Examples 3, 7, and 8.

### INDUSTRIAL APPLICABILITY

The manufacturing method of the present embodiment is suitable for the POF manufacture.

1. A fiber manufacturing method comprising:
discharging a softened linear body through a nozzle; and
winding the linear body so that the linear body passes through a cooling portion supplied with a cooling fluid, thereby obtaining a fiber, wherein
the cooling portion has a filter configured to rectify the cooling fluid,
the cooling fluid in the cooling portion has a temperature that is substantially constant in a moving direction of the linear body, and
an index M determined by the following equation (I) is 1.52 or less
$$\text{M} \left[-\right] \text{=} \frac{\text{K}}{π} \frac{{\text{Q}}_{\text{a}}}{\text{L}} \frac{\text{1}}{\left({\text{T}}_{\text{w}} - {\text{T}}_{\text{a}}\right)} {\left(\frac{{\text{D}}_{\text{f}}}{{\text{D}}_{\text{n}}}\right)}^{\text{2}} \text{U} \qquad \text{(I)}$$
where Qₐ is a flow rate (m³/s) of the cooling fluid to be supplied to the cooling portion,
L is a moving distance (m) of the linear body in the cooling portion,
T_{w} is a temperature (°C) of the linear body immediately after discharge through the nozzle,
Tₐ is a temperature (°C) of the cooling fluid,
D_{f} is an outer diameter (m) of the fiber,
Dₙ is an outer diameter (m) of the linear body immediately after the discharge through the nozzle,
U is a winding speed (m/s) for the linear body, and
K is 1.0 × 10⁸ (°C•s²/m³).

2. The fiber manufacturing method according to claim 1, wherein the index M is 1.0 or less.

3. The fiber manufacturing method according to claim 1, wherein
the temperature T_{w} of the linear body immediately after the discharge through the nozzle is 100° C. or higher.

4. The fiber manufacturing method according to claim 1, wherein
the linear body is cooled in the cooling portion by being brought into contact with the cooling fluid.

5. The fiber manufacturing method according to claim 1, wherein
the cooling portion has a tubular cooling pipe, and
the cooling fluid is supplied to an internal space of the cooling pipe, and the linear body passes through the internal space of the cooling pipe.

6. The fiber manufacturing method according to claim 5, wherein the cooling pipe is connected to the nozzle and extends downward from the nozzle.

7. The fiber manufacturing method according to claim 5, wherein
the cooling pipe has a body portion, the body portion including an inner wall, an outer wall, and a containing space positioned between the inner wall and the outer wall, and
a refrigerant for cooling the cooling fluid is introduced into the containing space.

8. The fiber manufacturing method according to claim 5, wherein
the filter is tubular and is located in the internal space of the cooling pipe, and
the linear body passes through an internal space of the filter.

9. The fiber manufacturing method according to claim 1, wherein
the cooling fluid is a gas.

10. The fiber manufacturing method according to claim 1, wherein
the cooling fluid is air.

11. The fiber manufacturing method according to claim 1, wherein
the linear body has a core and a clad disposed on an outer circumference of the core, and
the fiber manufacturing method further comprises extruding a resin composition with an extruder to form the core.

12. The fiber manufacturing method according to claim 1, wherein
a ratio of a three-fold value of a standard deviation of the outer diameter of the fiber to an average value of the outer diameter of the fiber is 2.0% or less.

13. The fiber manufacturing method according to claim 1, wherein
the fiber is a plastic optical fiber.
